(19) United States
(12) Patent Application Publication
(10) Pub. No.: US 2022/0137910 A1
(43) Pub. Date: May 5, 2022

(54) INFORMATION PROCESSING DEVICE AND CONTROL METHOD

(71) Applicant: Lenovo (Singapore) Pte. Ltd., Singapore (SG)

(72) Inventors: Yoshinori Ito, Kanagawa (JP); Kyoko Kawamura, Kanagawa (JP); Noritoshi Yoshiyama, Kanagawa (JP)

(73) Assignee: Lenovo (Singapore) Pte. Ltd., Singapore (SG)

(21) Appl. No.: 17/172,424

(22) Filed: Feb. 10, 2021

(30) Foreign Application Priority Data
Nov. 5, 2020 (JP) 2020-185068

(51) Int. Cl. G06F 3/14

(52) U.S. Cl. CPC G06F 3/1431

(57) ABSTRACT

An information processing device capable of controlling a display in each of two or more display areas that do not overlap one another includes: a display control unit that, when a window corresponding to a running application is displayed in a first display area among the two or more display areas, displays a new window corresponding to the running application in the first display area, and when the window corresponding to the running application is displayed in a second display area among the two or more display areas, displays the new window corresponding to the running application in the second display area.

### TECHNICAL FIELD

The present invention relates to an information processing device and a control method.

### BACKGROUND

In recent years, there has been an information processing device having plural screens (for example, two screens). For example, an information processing device having a two-screen structure in which display units are mounted respectively on a first chassis and a second chassis rotatable through a coupling unit (hinge mechanism) is disclosed (for example, Japanese Unexamined Patent Application Publication No. 2015-233198).

Further, there is an information processing device in which a flexible display (display unit) such as an organic EL display is provided over a first chassis and a second chassis in a manner to be bendable according to the rotation between the first chassis and the second chassis (for Publication No. 2018-13850). Even when one display unit is thus provided over the first chassis and the second chassis, the display unit can be split into a display area on the first chassis side and a display area on the second chassis side, and used as a pseudo two-screen structure.

However, in the case of using in the two-screen structure in which one is the primary screen and the other is the secondary screen, a newly opened window is usually displayed on the primary screen. Therefore, for example, when a user is working with a second application for which a window is being displayed on the secondary screen while looking at a first application for which a window is being displayed on the primary screen, if a new window (for example, a sub-window) is opened in the second application, this new window may be displayed on the primary screen to make the first application invisible.

### SUMMARY

One or more embodiments of the present invention provide an information processing device and a control method which provide a display in two or more display areas more properly.

According to one or more embodiments, the first aspect of the present invention provides an information processing device capable of controlling a display in each of a plurality of display areas that do not overlap one another, including a display control unit which, when a window corresponding to a running application is being displayed in a first display area among the plurality of display areas, displays a new window corresponding to the application in the first display area, while when a window corresponding to a running application is being displayed in a second display area among the plurality of display areas, displays a new window corresponding to the application in the second display area.

The above information processing device may further include: a first association unit which stores first association information in which information indicative of a first application corresponding to a window being displayed in the first display area among the plurality of display areas is associated with information indicative of the first display area; and a second association unit which stores second association information in which information indicative of a second application corresponding to a window being displayed in the second display area among the plurality of display areas is associated with information indicative of the second display area, wherein when a new window corresponding to the first application is displayed, the display control unit refers to the first association information to display the new window in the first display area, while when a new window corresponding to the second application is displayed, the display control unit refers to the second association information to display the new window in the second display area.

The above information processing device may also be such that, even when the window being displayed in the first display area is moved to the second display area or when the window being displayed in the second display area is moved to the first display area, the display control unit refers to the first association information and the second association information before the movement to display the new window corresponding to the first application in the first display area or to display the new window corresponding to the second application in the second display area.

The above information processing device may further be such that when the window being displayed in the first display area is moved to the second display area or when the window being displayed in the second display area is moved to the first display area, the first association unit and the second association unit update the first association information and the second association information according to a display state after the movement.

The above information processing device may further include a determination unit which determines in which display area among the plurality of display areas a window corresponding to a running application is being displayed, wherein when the window corresponding to the application is being displayed across the first display area and the second display area, the determination unit determines that the window is being displayed in one display area higher in terms of percentage of the displayed window than the other between the first display area and the second display area, and when a new window corresponding to the application is displayed, the display control unit displays the new window in the display area determined by the determination unit.

The above information processing device may be such that when the new window corresponding to the application is displayed, the display control unit displays the new window in the whole of the display area determined by the determination unit.

The second aspect of the present invention provides a control method for an information processing device capable of controlling a display in each of a plurality of display areas that do not overlap one another, the control method including: a step in which, when a window corresponding to a running application is being displayed in a first display area among the plurality of display areas, a display control unit is caused to display a new window corresponding to the application in the first display area; and a step in which, when a window corresponding to a running application is being displayed in a second display area among the plurality of display areas, the display control unit is caused to display a new window corresponding to the application in the second display area.

The above-described aspects of the present invention can provide a display in two or more display areas more properly.

### BRIEF DESCRIPTION OF THE DRAWINGS

FIGS. 1(A)-1(C) are explanatory diagrams of an overview of an information processing device according to a first embodiment.

FIG. 2 is a perspective view illustrating the appearance of the information processing device according to the first embodiment.

FIG. 3 is a side view illustrating an example of the information processing device in a bent state according to the first embodiment.

FIG. 4 is a side view illustrating an example of the information processing device in a flat state according to the first embodiment.

FIG. 5 is a diagram illustrating specific examples of various display modes of the information processing device according to the first embodiment.

FIG. 6 is a block diagram illustrating a hardware configuration example of the information processing device according to the first embodiment.

FIG. 7 is a block diagram illustrating a functional configuration example related to display control processing according to the first embodiment.

FIGS. 8(A)-8(B) are diagrams illustrating a window display example when a window is moved according to the first embodiment.

FIG. 9 is a flowchart illustrating an example of window display control processing according to the first embodiment.

FIGS. 10(A)-10(B) are diagrams illustrating a window display example according to a second embodiment.

FIG. 11 is a flowchart illustrating an example of window display control processing according to the second embodiment.

FIG. 12 is a block diagram illustrating a hardware configuration example of an information processing device according to a third embodiment.

FIG. 13 is a block diagram illustrating an example of the functional configuration related to display control processing according to the third embodiment.

### DETAILED DESCRIPTION

Embodiments of the present invention will be described below with reference to the accompanying drawings.

### First Embodiment

First, an overview of a first embodiment of the present invention will be described.

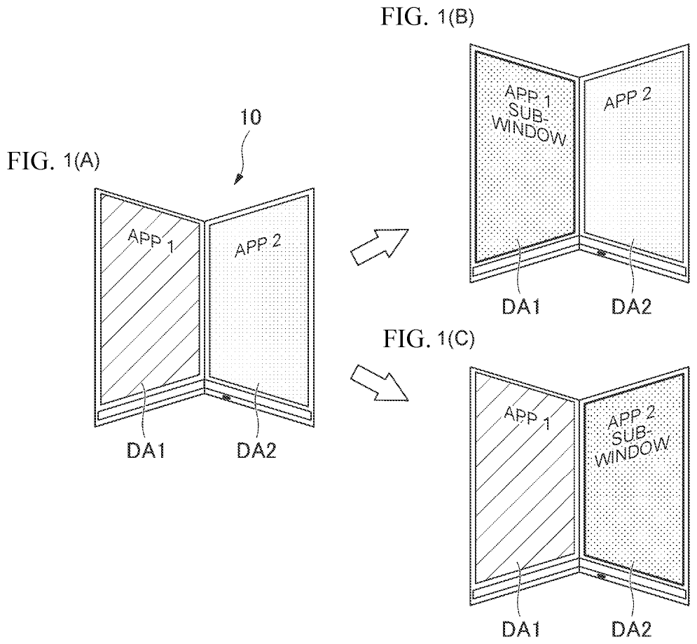

FIG. 1 is an explanatory diagram of an overview of an information processing device 10 according to the present embodiment. The information processing device 10 according to the present embodiment is a clamshell (laptop) PC (Personal Computer). The information processing device 10 has two display areas (that is, two screens) of a first display area DA1 and a second display area DA2 that do not overlap each other. In the illustrated example, an example of a usage form (a so-called book mode) in which left and right pages when a book is opened correspond to left and right screens is illustrated, thus having a two-screen structure in which the first display area DA1 is the left screen and the second display area DA2 is the right screen. Here, the left first display area DA1 corresponds to a primary-side screen and the right second display area DA2 corresponds to a secondary-side screen. Note that it is also possible to set the second display area DA2 as the primary screen and the first display area DA1 as the secondary screen. Further, it is possible to switch the selection as to which area is set to the primary screen based on a device state obtained from user operations or values read from various sensors, a usage history, and the like. For example, a UI (User Interface) to switch between the primary screen and the secondary screen of the information processing device 10 may be displayed in either one or both of the first display area DA1 and the second display area DA2 to switch between the primary screen and the secondary screen according to a user operation to the UI.

In the example illustrated in FIG. 1(A), windows of different running applications (hereinafter abbreviated as “apps”) are being displayed in the first display area DA1 and the second display area DA2, respectively. A window of app 1 is being displayed in the first display area DA, and a window of app 2 is being displayed in the second display area DA2. Here, suppose that a newly opened window is basically displayed on the primary side. In this case, for example, when a sub-window of the app 2 is opened, the sub-window is displayed in a manner to be superimposed on the window of the app 1 on the primary side, and hence the window of the app 1 becomes invisible. As an example, suppose that the app 1 is a browser and the app 2 is a mailer, and a user is working with the mailer being displayed in the second display area DA2 while looking at the browser being displayed in the first display area DA1. In this case, when a sub-window (for example, new e-mail) of the mailer is opened and displayed in the first display area DA1, it is inconvenient because the browser becomes invisible.

Therefore, when a sub-window of the app 1 whose window is being displayed in the first display area DA1 is opened, the information processing device 10 according to the present embodiment displays the sub-window in the first display area DA1 as illustrated in FIG. 1(B), and when a sub-window of the app 2 whose window is being displayed in the second display area DA2 is opened, the information processing device 10 displays the sub-window in the second display area DA2 as illustrated in FIG. 1(C). Thus, since the app being displayed in one display area does not interfere with the visibility of the app being displayed in the other display area, the display in two or more display areas can be provided properly and this is convenient.

The structure/configuration of the information processing device 10 according to the present embodiment will be described in detail below.

[Appearance Structure of Information Processing Device]

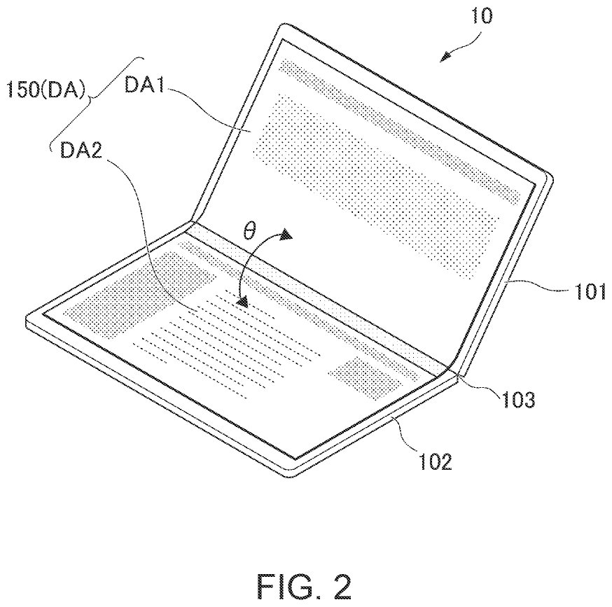

FIG. 2 is a perspective view illustrating the appearance of the information processing device 10 according to the present embodiment. The information processing device 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the axis of rotation of the hinge mechanism 103. A state where an open angle θ between the first chassis 101 and the second chassis 102 around the axis of rotation is substantially 0° is a state where the first chassis 101 and the second chassis 102 are closed in a manner to overlap each other. The state where the first chassis 101 and the second chassis 102 are closed is called a “closed state” (closed). Surfaces of the first chassis 101 and the second chassis 102 on the sides to face each other in the closed state are called “inner surfaces,” and surfaces on the other sides of the inner surfaces are called “outer surfaces,” respectively. The open angle θ can also be called an angle between the inner surface of the first chassis 101 and the inner surface of the second chassis 102. As opposed to the closed state, a state where the first chassis 101 and the second chassis 102 are open is called an “open state.” The open state is a state where the first chassis 101 and the second chassis 102 are rotated relative to each other until the open angle θ exceeds a preset threshold value (for example, 10°).

Further, a display unit 150 is provided over the inner surface of the first chassis 101 and the inner surface of the second chassis 102. For example, the display unit 150 has a flexible display bendable according to the open angle θ by the relative rotation between the first chassis 101 and the second chassis 102. As the flexible display, an organic EL display or the like is used. The information processing device 10 can be used both in a one-screen structure using the whole of a display area DA of the display unit 150 as one screen, and in a pseudo two-screen structure in which the display area DA of the display unit 150 is split into two display areas of the first display area DA1 and the second display area DA2, which do not overlap each other. Here, it is assumed that a display area corresponding to the inner surface side of the first chassis 101 in the display area DA (screen area) of the display unit 150 is set as the first display area DA1 and a display area corresponding to the inner surface side of the second chassis 102 is set as the second display area DA2. Note that a touch sensor is provided on the display area DA of the display unit 150 to be able to detect touch operations to the first display area DA1 and the second display area DA2. By putting the information processing device 10 into the open state, the user can visually confirm and perform touch operations to the display areas of the display unit 150 provided on the respective inner surfaces of the first chassis 101 and the second chassis 102, thus enabling use of the information processing device 10.

Further, usage forms of the information processing device 10 are divided into a state in which the first chassis 101 and the second chassis 102 are bent at an open angle θ between the first chassis 101 and the second chassis 102 (Bent form), and a flat state (Flat form) in which the first chassis 101 and the second chassis 102 are not bent.

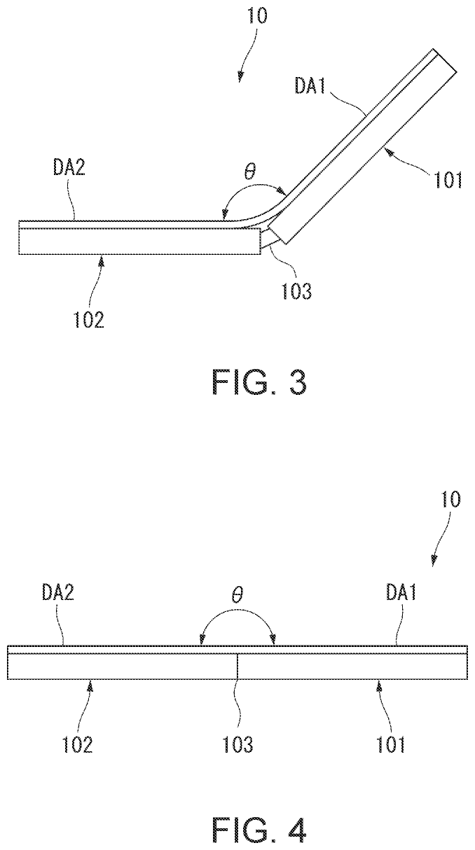

FIG. 3 is a side view illustrating an example of the information processing device 10 in the bent state (Bent form). The information processing device 10 determines the bent state (Bent form) according to the open angle θ. As an example, in the case of 10°<θ<170°, the information processing device 10 determines the bent state (Bent form). This state corresponds to a usage form as a so-called clamshell mode or book mode.

FIG. 4 is a side view illustrating an example of the information processing device 10 in the flat state (Flat form). The information processing device 10 typically determines the flat state (Flat form) when the open angle θ is 180°, but as an example, the information processing device 10 may also determine the flat state (Flat form) in the case of 170°≤θ≤180°. This state corresponds to a usage form as a so-called tablet mode.

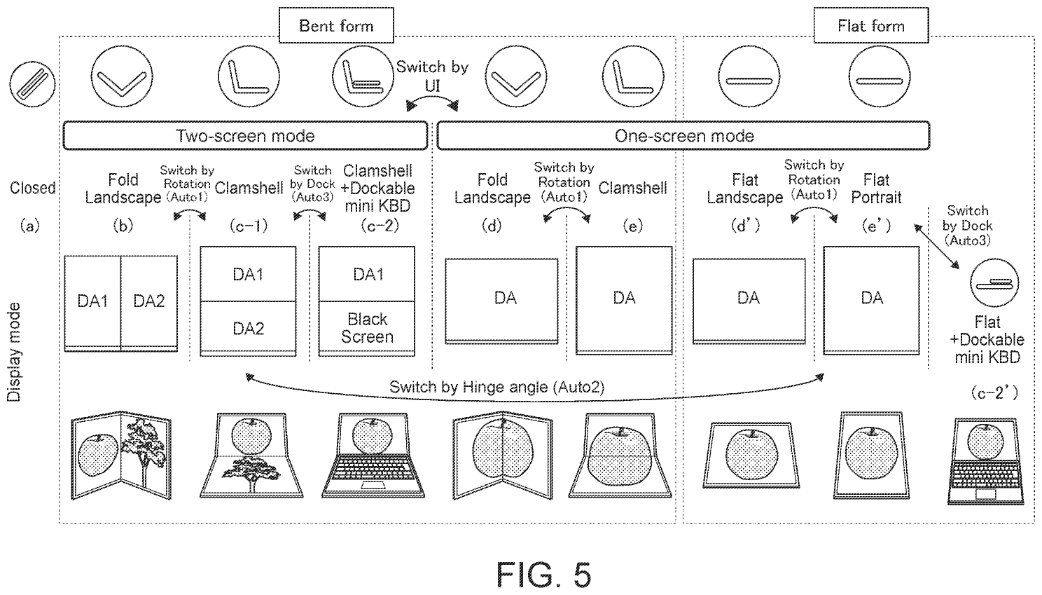

Referring next to FIG. 5, display modes in various usage forms of the information processing device 10 will be described in detail.

FIG. 5 is a diagram illustrating specific examples of various display modes of the information processing device 10 according to the present embodiment. The display mode of the information processing device 10 varies depending on the usage form classified by the open angle θ between the first chassis 101 and the second chassis 102, the posture (orientation) of the information processing device 10, whether the display mode is the one-screen mode or the two-screen mode, and the like. Note that one screen is also called a single screen, and two screens are also called split screens or dual screens.

Display mode (a) is a display mode when the first chassis 101 and the second chassis 102 are in the closed state (Closed) as the usage form. For example, in this closed state, the information processing device 10 is in a standby state, such as a sleep state or a hibernation state, and the display unit 150 is in a display-off state.

Display mode (b) is a display mode when the first chassis 101 and the second chassis 102 are in the bent state (Bent form) as the usage form, and the display mode is the two-screen mode in which the display is so controlled that the display area of the display unit 150 is split into two display areas of the first display area DA1 and the second display area DA2. Further, the orientation of the information processing device 10 is an orientation in which the first display area DA1 and the second display area DA2 are lined up side by side in portrait orientation. The portrait orientation of the display areas means an orientation in which long sides of the four sides of each of the rectangular display areas are in a longitudinal direction and short sides are in a lateral direction. The longitudinal direction corresponds to the vertical (up and down) direction, and the lateral direction corresponds to the horizontal (right and left) direction. The vertical direction is typically a gravitational direction. This usage form corresponds to a so-called book mode described with reference to FIG. 1. Since this display mode is in the bent state (Bent form), and the combined display area of the first display area DA1 and the second display area DA2 lined up side by side is horizontally long, it is also called “Fold Landscape.” In this display mode (b), for example, the information processing device 10 is in such a two-screen display mode that the first display area DA1 on the left side is set as the primary screen and the second display area DA2 on the right side is set as the secondary screen in normal operating conditions.

Note that the correspondences of the first display area DA1 and the second display area DA2 to the primary screen and the secondary screen in the display mode (b) may be reversed.

Like the display mode (b), display mode (c-1) is a display mode when the first chassis 101 and the second chassis 102 are in the bent state (Bent form), and the display mode is the two-screen mode in which the display is so controlled that the display area of the display unit 150 is split into two display areas of the first display area DA1 and the second display area DA2, but the orientation of the information processing device 10 as the usage form is different. The orientation of the information processing device 10 is an orientation in which the first display area DA1 and the second display area DA2 are lined up and down in landscape orientation. The landscape orientation of the display areas means an orientation in which long sides of the four sides of each of the rectangular display areas are in the lateral direction and short sides are in the longitudinal direction. This usage form is one of general usage forms of a clamshell PC. In this display mode (c-1), for example, the information processing device 10 is in such a two-screen display mode that the first display area DA1 is set as the primary screen and the second display area DA2 is set as the secondary screen in normal operating conditions.

Note that the correspondences of the first display area DA1 and the second display area DA2 to the primary screen and the secondary screen in the display mode (c-1) may be reversed.

The information processing device 10 detects a change in the posture (orientation) of the information processing device 10 to automatically switch from the display mode (b) to the display mode (c-1) or from the display mode (c-1) to the display mode (b) (Switch by Rotation).

Like the display mode (c-1), display mode (c-2) is a display mode in the bent state (Bent form) and the two-screen mode, and the orientation of the information processing device 10 is the same but different in that an external physical keyboard is connected. This usage form is in such a state that the keyboard is connected in the general usage form of the clamshell PC. For example, the external keyboard (Dockable mini KBD (KeyBorD)) connectable to the information processing device 10 is substantially equivalent in size to the second display area DA2 and placed on the second display area DA2 to realize a usage form similar to that of a traditional clamshell PC equipped originally with a physical keyboard. The information processing device 10 and the external keyboard are connected, for example, through Bluetooth (registered trademark). In this display mode (c-2), for example, the information processing device 10 is in such a two-screen display mode that the first display area DA1 is set as the primary screen and the second display area DA2 is set as the secondary screen in normal operating conditions. However, since the second display area DA2 becomes invisible by the keyboard, a black display is provided or the display is turned off. Therefore, the display mode (c-2) is virtually the one-screen display mode.

When detecting the connection with the external keyboard in the state of the display mode (c-1), the information processing device 10 automatically switches from the display mode (c-1) to the display mode (c-2) (Switch by Dock).

Like the display mode (b), display mode (d) is in the bent state (Bent form) in which the first chassis 101 and the second chassis 102 are bent, and the orientation of the information processing device 10 is the same but different in that the display mode is the one-screen mode in which the display is so controlled that the first display area DA1 and the second display area DA2 are combined as one display area DA of the display unit 150. Although this usage form is the one-screen mode different from the display mode (b), since it is the bent state (Bent form) and the display area DA is horizontally long, it is also called “Fold Landscape.” In this display mode (d), for example, the information processing device 10 is in such a one-screen display mode that the display area DA is set as the primary screen corresponding to the first display area DA1 in the two-screen mode in normal operating conditions.

Here, the two-screen mode and the one-screen mode are switched, for example, with a user's operation. For example, the information processing device 10 displays, on a task bar, an operation icon (hereinafter called a “screen mode switching icon”) as a UI (User Interface) to switch between the two-screen mode and the one-screen mode. This screen mode switching icon functions as a toggle switch which switches alternately between the two-screen mode and the one-screen mode each time it is operated. Then, when detecting an operation on the screen mode switching icon in the state of the display mode (b), the information processing device 10 switches from the display mode (b) to the display mode (d) (Switch by UI).

Note that the UI to switch between the two-screen mode and the one-screen mode is not limited to the icon displayed on the task bar, and any other UI can be used. For example, the UI to switch between the two-screen mode and the one-screen mode may be an icon displayed on a tool bar. Further, the information processing device 10 may display a dialog screen on which switching between the two-screen mode and the one-screen mode can be set, and control the display mode to a screen mode set with a user's operation on the dialog screen.

Like the display mode (c-1), display mode (e) is in the bent state (Bent form) in which the first chassis 101 and the second chassis 102 are bent, and the orientation of the information processing device 10 is the same but different in that the display mode is the one-screen mode in which the display is so controlled that the first display area DA1 and the second display area DA2 are combined as one display area DA of the display unit 150. Although this usage form is the one-screen mode different from the display mode (c-1), it is one of general usage forms of the clamshell PC. In this display mode (e), for example, the information processing device 10 is in such a one-screen display mode that the display area DA is set as the primary screen corresponding to the first display area DA1 in the two-screen mode in normal operating conditions.

The information processing device 10 automatically switches from the display mode (d) to the display mode (e) or from the display mode (e) to the display mode (d) by detecting a change in the posture (orientation) of the information processing device 10 (Switch by Rotation).

Like the display mode (d), display mode (d′) is in the one-screen mode and the orientation of the information processing device 10 is such an orientation that the display area DA is horizontally long, but different in that the information processing device 10 is in the flat state (Flat form) in which the first chassis 101 and the second chassis 102 are not bent. The flat state (Flat form) is a state in which the open angle θ between the first chassis 101 and the second chassis 102 is substantially 180°. This usage form corresponds to the so-called tablet mode described with reference to FIG. 4. Since this usage form is in the flat state (Flat form) and the display area DA is horizontally long, it is also called “Flat Landscape.” This display mode (d′) differs from the display mode (d) only in the open angle θ between the first chassis 101 and the second chassis 102. Like in the display mode (d), for example, the information processing device 10 in the display mode (d′) is in such a one-screen display mode that the display area DA is set as the primary screen corresponding to the first display area DA1 in the two-screen mode in normal operating conditions.

Like the display mode (e), display mode (e′) is in the one-screen mode and the orientation of the information processing device 10 is such an orientation that the display area DA is vertically long, but different in that the information processing device 10 is in the flat state (Flat form) in which the first chassis 101 and the second chassis 102 are not bent. Since this usage form is in the flat state (Flat form) and the display area DA is vertically long, it is also called “Flat Portrait.” This display mode (e′) differs from the display mode (e) only in the open angle θ between the first chassis 101 and the second chassis 102. Like in the display mode (e), for example, the information processing device 10 in the display mode (e′) is in such a one-screen display mode that the display area DA is set as the primary screen corresponding to the first display area DA1 in the two-screen mode in normal operating conditions.

The information processing device 10 automatically switches from the display mode (d′) to the display mode (e′) or from the display mode (e′) to the display mode (d′) by detecting a change in the posture (orientation) of the information processing device 10 (Switch by Rotation).

Further, when detecting the connection with the external keyboard in the state of the display mode (e′), the information processing device 10 automatically switches from the display mode (e′) to display mode (c-2′) (Switch by Dock). The display mode (c-2′) differs from the display mode (c-2) only in the open angle θ between the first chassis 101 and the second chassis 102. In the display mode (c-2′), for example, the information processing device 10 is in such a two-screen display mode that the first display area DA1 is set as the primary screen and the second display area DA2 is set as the secondary screen in normal operating conditions. However, since the second display area DA2 becomes invisible by the keyboard, a black display is provided or the display is turned off. Therefore, the display mode (c-2′) is virtually the one-screen display mode.

Further, when detecting a change from the flat state (Flat form) in which the first chassis 101 and the second chassis 102 are not bent to the bent state (Bent form), the information processing device 10 switches from the one-screen mode to the two-screen mode. For example, when detecting a change to the bent state (Bent form) in the state of the display mode (d′) based on the open angle θ between the first chassis 101 and the second chassis 102, the information processing device 10 automatically switches from the display mode (d′) to the display mode (b). Further, when detecting a change to the bent state (Bent form) in the state of the display mode (e′) based on the open angle θ between the first chassis 101 and the second chassis 102, the information processing device 10 automatically switches from the display mode (e′) to the display mode (c-1).

Note that, for example, in the display modes (b), (c-1), (c-2), (d), (e), (d′), (e′), and (c-2′), the task bar may be displayed only in one place inside the display area (for example, on the bottom of the display area) regardless of whether the display mode is the one-screen mode or the two-screen mode.

(Configuration of Information Processing Device 10)

A specific configuration of the information processing device 10 will be described below.

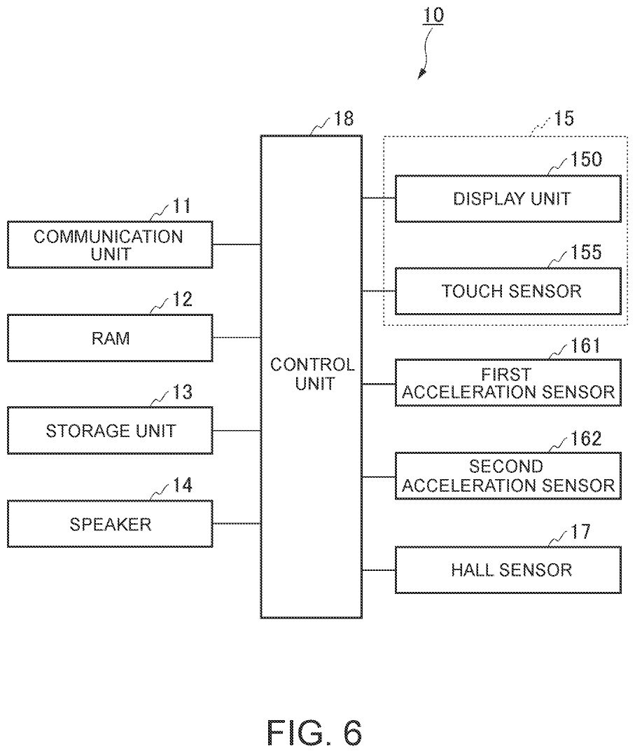

FIG. 6 is a block diagram illustrating an example of the hardware configuration of the information processing device 10 according to the present embodiment. The information processing device 10 includes a communication unit 11, a RAM (Random Access Memory) 12, a storage unit 13, a speaker 14, a touch screen 15, a first acceleration sensor 161, a second acceleration sensor 162, a Hall sensor 17, and a control unit 18. These units are connected communicably to one another through a bus or the like.

The communication unit 11 is, for example, configured to include digital input/output ports such as plural Ethernet (registered trademark) ports and plural USB (Universal Serial Bus) ports, communication devices for performing wireless communication such as Bluetooth (registered trademark) and Wi-Fi (registered trademark), and the like. For example, the communication unit 11 is connected with the external keyboard described above and the like by using Bluetooth (registered trademark).

In the RAM 12, programs and data for processing executed by the control unit 18 are expanded, and various data are saved or deleted as appropriate. For example, the RAM 12 also functions as a video memory (V-RAM) for the display of the display unit 150. As an example, the RAM 12 functions as a video memory for data displayed in the display area DA when the display unit 150 is controlled in the one-screen mode. Further, the RAM 12 functions as a video memory for data displayed in the first display area DA1 and the second display area DA2 when the display unit 150 is controlled in the two-screen mode. Further, association information indicating in which of the first display area DA1 and the second display area DA2 the window of each app executed in the two-screen mode is being displayed, and the like are stored in the RAM 12. Note that, since the RAM 12 is a volatile memory, no data is held after the supply of power is stopped.

The storage unit 13 is configured to include an SSD (Solid State Drive), an HDD (Hard Disk Drive), a flash-ROM (Read Only Memory), and the like. For example, in the storage unit 13, a BIOS (Basic Input Output System) program and setting data, an OS (Operating System) and app programs running on the OS, various data used in the apps, and the like are stored.

The speaker 14 outputs electronic sound, voice, and the like.

The touch screen 15 includes the display unit 150 and a touch sensor 155. As described above, the display unit 150 has the flexible display bendable according to the open angle θ by the relative rotation between the first chassis 101 and the second chassis 102. Under the control of the control unit 18, the display unit 150 provides a display corresponding to each display mode described with reference to FIG. 5. The touch sensor 155 is provided on the screen of the display unit 150 to detect a touch operation on the screen. For example, in the one-screen mode, the touch sensor 155 detects a touch operation in the display area DA. Further, in the two-screen mode, the touch sensor 155 detects a touch operation(s) in either or both of the first display area DA1 and the second display area DA2. The touch operations include a tap operation, a slide operation, a flick operation, a swipe operation, a pinch operation, and the like. The touch sensor 155 detects a touch operation and outputs, to the control unit 18, operation information based on the detected operation.

The first acceleration sensor 161 is provided inside the first chassis 101 to detect the orientation of the first chassis 101 and a change in orientation. For example, when a direction parallel to the long-side direction of the first display area DA1 is set as an X1 direction, a direction parallel to the short-side direction of the first display area DA1 is set as a Y1 direction, and a direction perpendicular to the X1 direction and the Y1 direction is set as a Z1 direction, the first acceleration sensor 161 detects acceleration in the X1 direction, the Y1 direction, and the Z1 direction, respectively, and outputs the detection results to the control unit 18.

The second acceleration sensor 162 is provided inside the second chassis 102 to detect the orientation of the second chassis 102 and a change in orientation. For example, when a direction parallel to the long-side direction of the second display area DA2 is set as an X2 direction, a direction parallel to the short-side direction of the second display area DA2 is set as a Y2 direction, and a direction perpendicular to the X2 direction and the Y2 direction is set as a Z2 direction, the second acceleration sensor 162 detects acceleration in the X2 direction, the Y2 direction, and the Z2 direction, respectively, and outputs the detection results to the control unit 18.

The control unit 18 can detect the posture (orientation) of the information processing device 10 and the open angle θ between the first chassis 101 and the second chassis 102 based on the detection results of the first acceleration sensor 161 and the second acceleration sensor 162. Note that any other kind of sensor may also be used to detect the open angle θ.

The Hall sensor 17 is configured to include a Hall element and a magnet. The Hall element is provided inside either the first chassis 101 or the second chassis 102, and the magnet is provided inside the other chassis. For example, the Hall element and the magnet are provided inside the first chassis 101 and the second chassis 102 in corresponding positions, respectively. More specifically, the Hall element and the magnet are provided in positions to face each other in the closed state. The magnetic field detected by the Hall element varies between the open state and the closed state of the first chassis 101 and the second chassis 102. The Hall sensor 17 is such that the Hall element arranged inside the first chassis 101 detects the magnetic field generated from the magnet arranged inside the second chassis 102 to output the detection result to the control unit 18. Based on the detection result of this Hall sensor 17, the control unit 18 can detect whether the information processing device 10 is in the open state or the closed state.

Note that the control unit 18 can also use a Hall sensor provided separately from the Hall sensor 17 to detect the connection of an external keyboard (Dockable mini KBD: KeyBorD) connectable to the information processing device 10 in order to detect the connection with the external keyboard (mini-KBD). For example, a magnet is provided on the side of the external keyboard (mini-KBD) and a Hall element is provided on the side of a corresponding chassis (for example, the second chassis 102). In this case, the magnetic field detected by the Hall element varies depending on whether the external keyboard (mini-KBD) is placed on a display area on the side of the second chassis 102 or not. The control unit 18 may detect the connection of the external keyboard (mini-KBD) based on the detection result of this Hall sensor.

The control unit 18 is configured to include a CPU (Central Processing Unit), a GPU (Graphic Processing Unit), a microcomputer (Microcomputer), and the like. The control unit 18 centrally controls the operation of the information processing device 10 to implement various functions by executing processing of the BIOS, the OS, and programs such as apps running on the OS.

Here, a functional configuration related to display control processing among pieces of processing executed by the control unit 18 will be described.

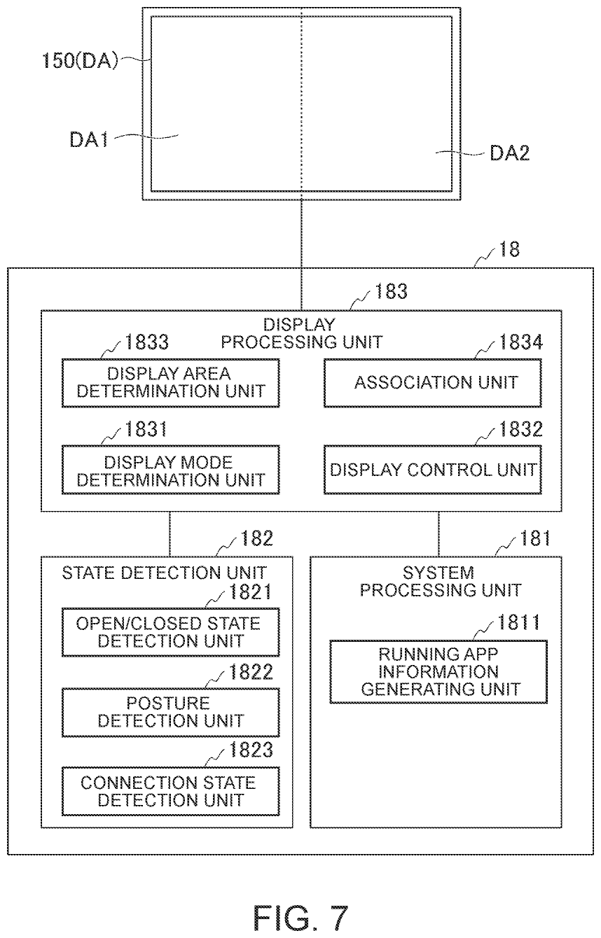

FIG. 7 is a block diagram illustrating an example of the functional configuration related to the display control processing according to the present embodiment. The illustrated control unit 18 includes functional components implemented by executing a program. The control unit 18 includes a system processing unit 181, a state detection unit 182, and a display processing unit 183. Here, the system processing unit 181 is a functional component the processing of which is executed by the CPU based, for example, on the OS. Further, the state detection unit 182 is a functional component the processing of which is executed by the microcomputer regardless, for example, of the presence or absence of the execution of OS processing. The display processing unit 183 is a functional component the processing of which is executed by the CPU based, for example, on a program running on the OS.

The system processing unit 181 boots the OS and executes an app program running on the OS. Further, the system processing unit 181 has a running app information generating unit 1811 which generates app information such as information indicative of running apps (for example, information including app IDs). The system processing unit 181 outputs, to the display processing unit 183, the app information generated by the running app information generating unit 1811.

The state detection unit 182 detects the state of the information processing device 10. For example, the state detection unit 182 includes an open/closed state detection unit 1821, a posture detection unit 1822, and a connection state detection unit 1823. The open/closed state detection unit 1821 detects whether the information processing device is in the open state or the closed state based on the detection result of the Hall sensor 17. When the information processing device 10 is in the open state, the open/closed state detection unit 1821 detects the open angle θ between the first chassis 101 and the second chassis 102 based on the detection results of the first acceleration sensor 161 and the second acceleration sensor 162. Then, based on the detected open angle θ, the open/closed state detection unit 1821 detects whether the first chassis 101 and the second chassis 102 are in the bent state (Bent form) or the flat state (Flat form) in which the first chassis 101 and the second chassis 102 are not bent. The posture detection unit 1822 detects the posture (orientation) of the information processing device 10 based on the detection results of the first acceleration sensor 161 and the second acceleration sensor 162. The connection state detection unit 1823 detects the connection with the external keyboard (mini-KBD). For example, the connection state detection unit 1823 uses the Hall sensor (not illustrated) for detecting the connection with the external keyboard (mini-KBD) described above to detect the connection with the external keyboard (mini-KBD). The state detection unit 182 outputs the detection results to the display processing unit 183.

The display processing unit 183 includes a display mode determination unit 1831, a display control unit 1832, a display area determination unit 1833, and an association unit 1834.

The display mode determination unit 1831 determines a display mode based on the detection results of the state of the information processing device 10 detected by the state detection unit 182. For example, the display mode determination unit 1831 acquires, from the state detection unit 182, the detection result of the open/closed state of the information processing device 10, the detection result of whether the first chassis 101 and the second chassis 102 are in the bent state (Bent form) or the flat state (Flat form) in which the first chassis 101 and the second chassis 102 are not bent when the information processing device 10 is in the open state, and the detection result of the posture (orientation) of the information processing device 10. Then, the display mode determination unit 1831 determines a display mode described with reference to FIG. 5 based on the respective detection results acquired from the state detection unit 182.

Based on the display mode determined by the display mode determination unit 1831, the display control unit 1832 controls the display of the display unit 150. Specifically, the display control unit 1832 controls the setting of the one-screen mode or the two-screen mode, the orientation of each display area, the display content of each display area, and the like.

The functional configuration of the window display control processing in the two-screen mode described with reference to FIG. 1 will be described in detail below. The display modes as targets for this window display control processing are the display mode (b) and the display mode (c-1) illustrated in FIG. 5.

The display area determination unit 1833 acquires, from the system processing unit 181, app information indicative of a running app (for example, information including an app ID), and determines in which of the first display area DA1 and the second display area DA2 a window corresponding to the running app is being displayed. For example, based on the center coordinates or the coordinates of the four corners of the window of the running app, the display area determination unit 1833 determines a display area in which the window is being displayed.

The association unit 1834 has a function as a first association unit which generates, based on the determination result of the display area determination unit 1833, first association information in which app information indicative of the app 1 (see FIG. 1(A)) corresponding to the window being displayed in the first display area DA1 (for example, the app ID of the app 1) is associated with information indicative of the first display area DA1, and stores the first association information in the RAM 12. Further, the association unit 1834 has a function as a second association unit which generates second association information in which app information indicative of the app 2 (see FIG. 1(A)) corresponding to the window being displayed in the second display area DA2 (for example, the app ID of the app 2) is associated with information indicative of the second display area DA2, and stores the second association information in the RAM 12.

When a window (main window) corresponding to a running app is being displayed in the first display area DA1, the display control unit 1832 displays a new sub-window corresponding to the app in the first display area DA1. On the other hand, when the window (main window) corresponding to the running app is being displayed in the second display area DA2, the display control unit 1832 displays a new sub-window corresponding to the app in the second display area DA2.

Specifically, when displaying the new sub-window corresponding to the app 1 being displayed in the first display area DA1, the display control unit 1832 refers to the first association information stored in the RAM 12 to display the new sub-window in the first display area DA1. On the other hand, when displaying the new sub-window corresponding to the app 2 being displayed in the second display area DA2, the display control unit 1832 refers to the second association information stored in the RAM 12 to display the new sub-window in the second display area DA2. In other words, when displaying a new sub-window corresponding to an app being displayed in the first display area DA1 or the second display area DA2, the display control unit 1832 displays the new sub-window in a display area determined by the display area determination unit 1833.

Further, when displaying the new sub-window corresponding to the app displayed in the first display area DA1 or the second display area DA2, the display control unit 1832 displays (full-screen displays) the new sub-window in the whole of the display area determined by the display area determination unit 1833.

Note that, when displaying the new sub-window, the display control unit 1832 may also display the new sub-window in a display area smaller than the whole of the display area, rather than to display (full-screen display) the new sub-window in the whole of the display area determined by the display area determination unit 1833. In this case, the display control unit 1832 may display the new sub-window in the center of the display area, or on the left side, right side, upper side, or lower side of the display area.

Here, the display position of the window (main window) of the app being displayed in the first display area DA1 or the second display area DA2 can be moved with a user's operation (for example, drag and drop). Therefore, the window may be displayed across the first display area DA1 and the second display area DA2.

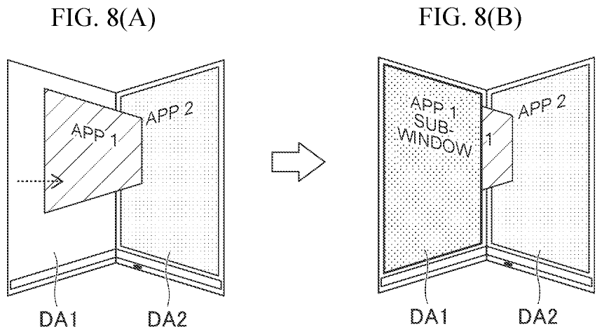

FIG. 8 is a diagram illustrating a window display example when a window is moved. FIG. 8(A) illustrates an example in which the window (main window) of the app 1 is displayed across the first display area DA1 and the second display area DA2. In the illustrated example, the window of the app 1 being displayed in the first display area DA1 is moved in the direction of the second display area DA2 with the user's operation, and part of the window is in the second display area DA2.

In this case, the display area determination unit 1833 determines that the window is being displayed in one display area higher in terms of percentage of the displayed window than the other between the first display area DA1 and the second display area DA2. For example, the display area determination unit 1833 may determine a display area containing the center coordinates of the window to be the display area higher in percentage of the displayed window, or determine a display area higher in terms of percentage of the displayed window based on the coordinates of the four corners of the window.

In the example illustrated in FIG. 8(A), the window (main window) of the app 1 is being displayed across the first display area DA1 and the second display area DA2. However, since the percentage of the displayed window is higher in the first display area DA1, the display area determination unit 1833 determines that the window of the app 1 is being displayed in the first display area DA1. Thus, as illustrated in FIG. 8(B), when a new sub-window corresponding to the app 1 is displayed, the display control unit 1832 can refer to the first association information stored in the RAM 12 to display the new sub-window in the first display area DA1 even if the window (main window) of the app 1 sticks out of the first display area DA1.

(Operation of Window Display Control Processing)

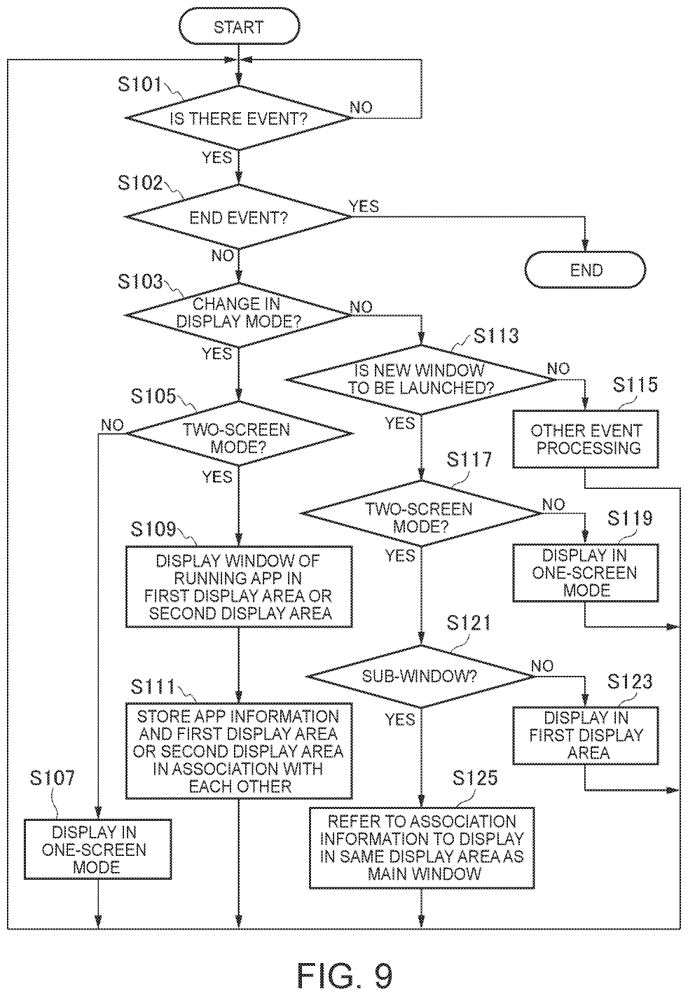

Next, the operation of the window display control processing executed by the control unit 18 in the two-screen mode will be described. FIG. 9 is a flowchart illustrating an example of the window display control processing according to the present embodiment.

(Step S101) The control unit 18 determines the presence or absence of an event. When determining that there is no event (NO), the control unit 18 performs the processing in step S101 again. On the other hand, when determining that there is an event (YES), the control unit 18 proceeds to processing in step S102.

(Step S102) The control unit 18 determines whether the event is an end event or not. The end event is, for example, to log off or shut down the OS. When determining that the event is the end event (YES), the control unit 18 ends the window display control processing. On the other hand, when determining that the event is not the end event (NO), the control unit 18 proceeds to processing in step S103.

(Step S103) The control unit 18 determines whether the event is to change the display mode or not. When determining that the event is to change the display mode (YES), the control unit 18 proceeds to processing in step S105. On the other hand, when determining that the event is not to change the display mode (NO), the control unit 18 proceeds to processing in step S113.

(Step S105) The control unit 18 determines whether the change in display mode is to change to a display mode in the two-screen mode or not. When determining that the change in the display mode is to change to a display mode in the one-screen mode (not to change to a display mode in the two-screen mode) (NO), the control unit 18 proceeds to step S107. On the other hand, when determining that the change in the display mode is to change to a display mode in the two-screen mode (YES), the control unit 18 proceeds to processing in step S109.

(Step S107) The control unit 18 controls the display in the one-screen mode. Then, the control unit 18 returns to the processing in step S101.

(Step S109) The control unit 18 displays a running app in the first display area DA1 or the second display area DA2 according to predetermined rules. For example, the control unit 18 displays, in the first display area DA1 (primary screen), the window of an app as an active window immediately before the switch from the one-screen mode to the two-screen mode, and displays, in the second display area DA2 (secondary screen), the window of an app as one of apps as inactive windows immediately before the switch from the one-screen mode to the two-screen mode. As an example, the window to be displayed in the second display area DA2 is a window that was the last active window among the inactive windows. Note that the window to be displayed in the second display area DA2 may also be selected at random from among the inactive windows. Alternatively, the control unit 18 may display windows of apps, which were inactive windows immediately before the switch from the one-screen mode to the two-screen mode, in the second display area DA2 (secondary screen) as thumbnails, and display a window selected from the thumbnails in the second display area DA2 (secondary screen). Then, the control unit 18 proceeds to processing in step S111.

(Step S111) The control unit 18 associates app information on an app, for which a window is displayed, with the first display area DA1 or the second display area DA2. Specifically, the control unit 18 generates and stores, in the RAM 12, first association information in which the app information on the app 1 being displayed in the first display area DA1 (for example, the app ID of the app 1) is associated with information indicative of the first display area DA1. Then, the control unit 18 returns to the processing in step S101. Further, the control unit 18 generates and stores, in the RAM 12, second association information in which the app information on the app 2 being displayed in the second display area DA2 (for example, the app ID of the app 2) is associated with information indicative of the second display area DA2. Then, the control unit 18 returns to the processing in step S101.

(Step S113) When determining in step S103 that the event is not to change the display mode (NO), the control unit 18 determines whether the event is to launch a new window or not. When determining that the event is not to launch a new window (NO), the control unit 18 proceeds to processing in step S115. On the other hand, when determining that the event is to launch a new window (YES), the control unit 18 proceeds to processing in step S117.

(Step S115) The control unit 18 executes event processing according to the content of any other event. Then, the control unit 18 returns to the processing in step S101.

(Step S117) The control unit 18 determines whether the current display mode is a display mode in the two-screen mode or not. When determining that the current display mode is a display mode in the one-screen mode (not to a display mode in the two-screen mode) (NO), the control unit 18 proceeds to step S119. On the other hand, when determining that the current display mode is a display mode in the two-screen mode (YES), the control unit 18 proceeds to processing in step S121.

(Step S119) The control unit 18 controls the display of a new window in the one-screen mode. Then, the control unit 18 returns to step S101.

(Step S121) The control unit 18 determines whether a window to be newly launched is a sub-window or not. When determining that the newly launched window is the main window (not a sub-window) (NO), the control unit 18 proceeds to step S123. On the other hand, when determining that the newly launched window is a sub-window (YES), the control unit 18 proceeds to processing in step S125.

(Step S123) The control unit 18 displays the newly launched window in the first display area DA1 (primary screen). Then, the control unit 18 returns to the processing in step S101.

(Step S125) The control unit 18 refers to the first association information and the second association information to display the sub-window in a display area associated with the app information on the app of the newly launched sub-window between the first display area DA1 and the second display area DA2. For example, when the newly launched sub-window is a window of the app 1, the control unit 18 displays the sub-window in the first display area DA1 in which the main window of the app 1 is being displayed. On the other hand, when the newly launched sub-window is a window of the app 2, the control unit 18 displays the sub-window in the second display area DA2 in which the main window of the app 2 is being displayed. In other words, the control unit 18 displays the newly launched sub-window in the same display area as the display area in which the main window of the same app is being displayed. Then, the control unit 18 returns to the processing in step S101.

As described above, the information processing device according to the present embodiment can control the display in each of the two or more display areas (for example, the first display area DA1 and the second display area DA2) that do not overlap each other. For example, when a window corresponding to a running app is being displayed in the first display area DA1, the information processing device 10 displays, in the first display area DA1, a new sub-window (an example of a window) corresponding to the app. On the other hand, when a window corresponding to a running app is being displayed in the second display area DA2, the information processing device 10 displays, in the second display area DA2, a new sub-window corresponding to the app.

Thus, since the information processing device 10 displays a sub-window corresponding to a running app in a display area in which a window corresponding to the running app is being displayed among the two or more display areas, the sub-window does not interfere with a window of any other app being displayed in any other display area. Thus, the information processing device 10 can provide a display in each of the two or more display areas properly.

For example, the information processing device 10 stores the first association information in which app information indicative of the app 1 (an example of a first application) corresponding to the window being displayed in the first display area DA1 is associated with information indicative of the first display area DA1. Further, the information processing device 10 stores the second association information in which app information indicative of the app 2 (an example of a second application) corresponding to the window being displayed in the second display area DA2. Then, when displaying a new sub-window corresponding to the app 1, the information processing device 10 refers to the first association information mentioned above to display the new sub-window in the first display area DA1. Further, when displaying a new sub-window corresponding to the app 2, the information processing device 10 refers to the second association information mentioned above to display the new sub-window in the second display area DA2.

Thus, the information processing device 10 can associate information on an app corresponding to a window (main window) being displayed in each display area with information indicative of the display area to display a sub-window in the same display area as that of the main window.

Further, the information processing device 10 determines in which of the two or more display areas a window corresponding to a running app is being displayed. For example, when a window corresponding to an app is being displayed across the first display area DA1 and the second display area DA2, the information processing device 10 determines that the window is being displayed in one display area higher in terms of the percentage of the displayed window than the other between the first display area DA1 and the second display area DA2. Then, the information processing device 10 displays a new sub-window corresponding to the app in the display area determined between the first display area DA1 and the second display area DA2 as mentioned above.

Thus, even when the window (main window) of an app is being displayed out of one display area with a user's operation, the information processing device 10 can display a new sub-window of the app in the display area in which the window (main window) is being displayed.

Further, when displaying a new sub-window corresponding to an app, the information processing device 10 displays (full-screen displays) the new sub-window in the whole of the display area determined as mentioned above between the first display area DA1 and the second display area DA2.

Thus, the information processing device 10 can display the sub-window having good visibility without interfering with the window of any other app displayed in the other display area.

In the present embodiment, even when the window of an app being displayed in one display area is moved to the other display area with a user's operation, a new sub-window corresponding to the moved app is displayed in the display area before the movement. For example, even when a window displayed in the first display area DA1 is moved to the second display area DA2, or when a window displayed in the second display area DA2 is moved to the first display area DA1, the information processing device 10 refers to the first association information and the second association information before the movement to display a new sub-window corresponding to the app 1 in the first display area DA1, or to display a new sub-window corresponding to the app 2 in the second display area DA2.

Thus, in the information processing device 10, even when the window of an app once launched is then moved from the first display area DA1 to the second display area DA2 or from the second display area DA2 to the first display area DA1, the display area in which a new sub-window corresponding to the app does not change, so it is easy to understand.

### Second Embodiment

Next, a second embodiment of the present invention will be described.

In the first embodiment, the example in which, even when the window of an app being displayed in one display area is moved to the other display area with a user's operation, a new sub-window corresponding to the moved app is displayed in the display area before the movement is described. In this case, the display area in which the new sub-window is opened does not change regardless of whether the window of the app is moved or not, so it is easy to understand. However, when the user intentionally moves the window of the app, it is considered that the user may intend to display a new sub-window corresponding to the moved app in a display area after the movement. Therefore, in the present embodiment, when the window of an app being displayed in one display area is moved to the other display area with a user's operation, the information processing device 10 displays a new sub-window corresponding to the moved app in the display area after the movement.

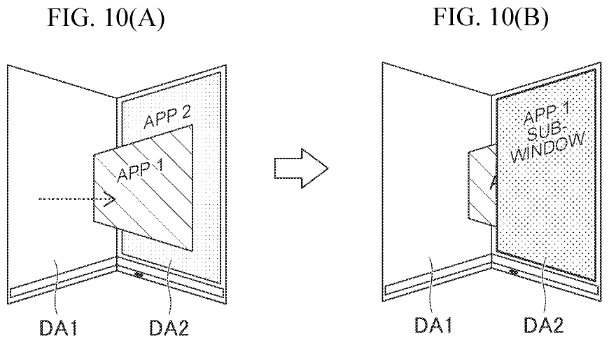

FIG. 10 is a diagram illustrating a window display example when a window is moved to any other display area according to the present embodiment. FIG. 10(A) illustrates an example in which the window (main window) of the app 1 being displayed in the first display area DA1 is moved to the second display area DA2 with a user's operation. In the illustrated example, the window (main window) of the app 1 is being displayed across the first display area DA1 and the second display area DA2. However, since the percentage of the displayed window is higher in the second display area DA2, the display area determination unit 1833 determines that the window of the app 1 is being displayed in the second display area DA2.

When a window being displayed in the first display area DA1 is moved to the second display area DA2, or when a window being displayed in the second display area DA2 is moved to the first display area DA1, the association unit 1834 updates the first association information and the second association information according to the display state after the movement. For example, when the window of the app 1 being displayed in the first display area DA1 is moved to the second display area DA2, the association unit 1834 deletes the first association information in which the app information of the app 1 is associated with the information indicative of the first display area DA1 (disassociation), and newly generates and stores, in the RAM 12, second association information in which the app information of the app 1 is associated with the information indicative of the second display area DA2. Further, when the window of the app 2 being displayed in the second display area DA2 is moved to the first display area DA1, the association unit 1834 deletes the second association information in which the app information of the app 2 is associated with the information indicative of the second display area DA2 (disassociation), and newly generates and stores, in the RAM 12, first association information in which the app information of the app 2 is associated with information indicative of the first display area DA1.

Thus, when the window of the app 1 being displayed in the first display area DA1 is moved to the second display area DA2, the display control unit 1832 refers to the second association information to display a new sub-window corresponding to the app 1 in the second display area DA2. Further, when the window of the app 2 being displayed in the second display area DA2 is moved to the first display area DA1, the display control unit 1832 refers to the first association information to display a new sub-window corresponding to the app 2 in the first display area DA1. Thus, the new sub-window can be displayed in the display area after the movement.

(Operation of Window Display Control Processing)

Next, window display control processing according to the present embodiment will be described.

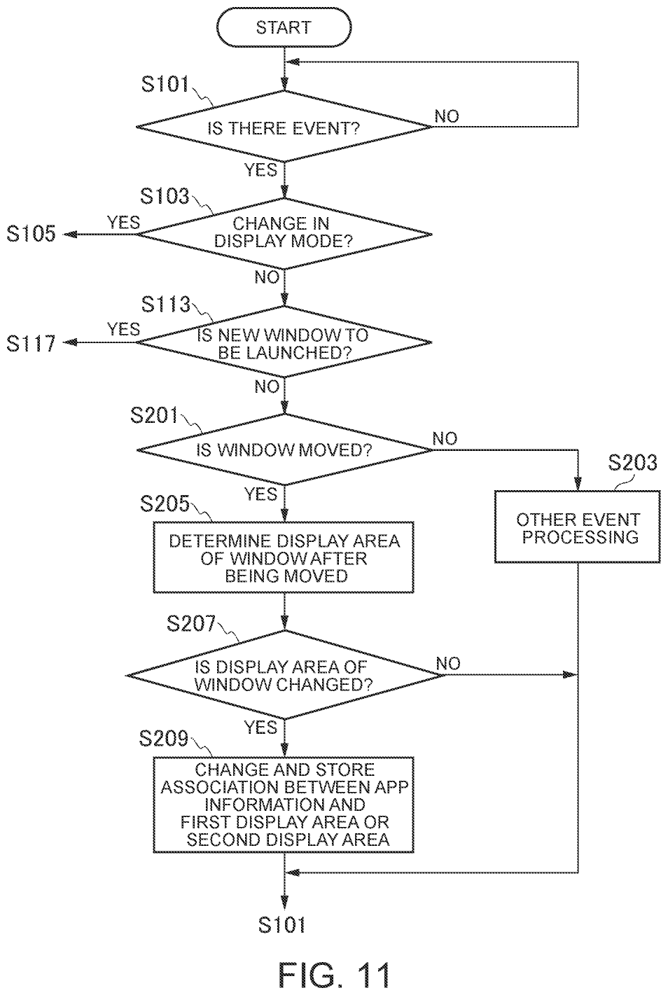

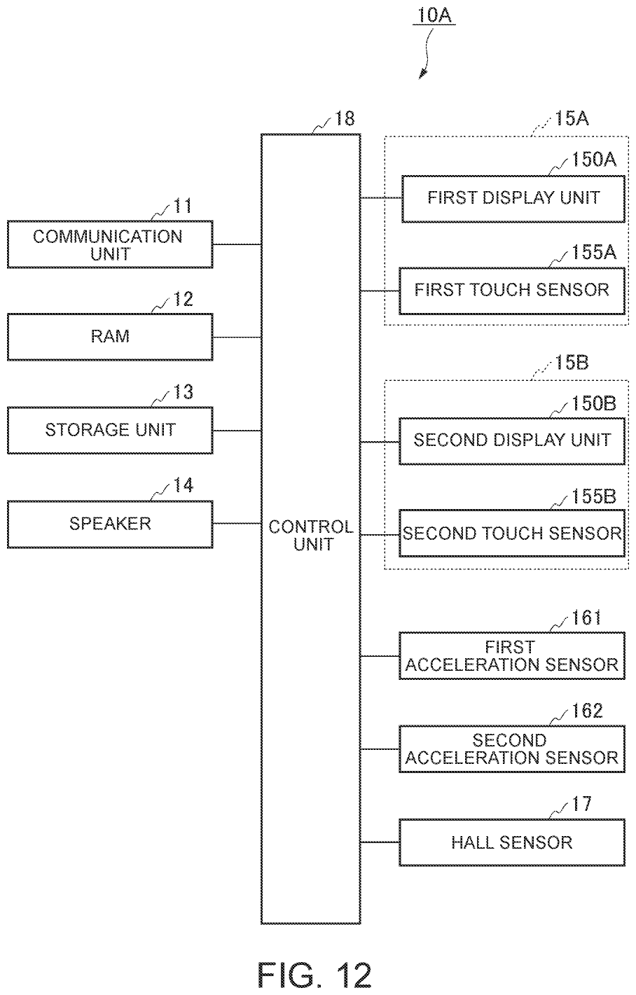

FIG. 11 is a flowchart illustrating an example of window display control processing according to the present embodiment. Here, display control processing including processing for updating association information between app information and one display area when a window of an app is moved to the other display area with a user's operation will be described. Note that the processing for updating the association information according to the movement of the window corresponds to one piece of the other event processing in step S115 of FIG. 9. In FIG. 11, the processing is the same as the processing in FIG. 9 except the processing after NO in step S113 of FIG. 9, and FIG. 9 omits the other part of the processing from the illustration.

When determining in step S101 that there is an event (YES), determining in step S103 that the event is not to change the display mode (NO), and determining in step S113 that the event is not to launch a new window (NO), the control unit 18 proceeds to processing in step S201.

(Step S201) The control unit 18 determines whether a window being displayed in the first display area DA1 or the second display area DA2 is moved or not. For example, the control unit 18 determines whether the window corresponding to the app 1 being displayed in the first display area DA1 or the window corresponding to the app 2 being displayed in the second display area DA2 is moved or not. When determining that neither the window corresponding to the app 1 nor the window corresponding to the app 2 is moved (NO), the control unit 18 proceeds to processing in step S203. On the other hand, when determining either the window corresponding to the app 1 or the window corresponding to the app 2 is moved (YES), the control unit 18 proceeds to processing in step S205.

(Step S203) The control unit 18 executes the event processing according to the content of any other event. Then, the control unit 18 returns to step S101 (see FIG. 9).

(Step S205) The control unit 18 determines in which of the first display area DA1 and the second display area DA2 the moved window is being displayed. Then, the control unit 18 proceeds to processing in step S207.

(Step S207) Based on the determination result in step S205, the control unit 18 determines whether the display area of the moved window is changed or not. For example, the control unit 18 determines whether the window corresponding to the app 1 is moved from the first display area DA1 to the second display area DA2, or whether the window corresponding to the app 2 is moved from the second display area DA2 to the first display area DA1 to determine whether the display area of the window is changed or not. When determining that the display area of the window is not changed (NO), the control unit 18 returns to the processing in step S101 (see FIG. 9). On the other hand, when determining that the display area of the window is changed (YES), the control unit 18 proceeds to processing in step S209.

(Step S209) When determining that the display area of the window is changed, the control unit 18 changes the association between the app information and the first display area DA1 or the second display area DA2. For example, when determining that the window corresponding to the app 1 is moved from the first display area DA1 to the second display area DA2, the control unit 18 deletes the first association information in which the app information of the app 1 (for example, the app ID of the app 1) is associated with the information indicative of the first display area DA1 (disassociation), and newly generates and stores, in the RAM 12, second association information in which the app information of the app 1 is associated with information indicative of the second display area DA2. Further, when determining that the window corresponding to the app 2 is moved from the second display area DA2 to the first display area DA1, the control unit 18 deletes the second association information in which the app information of the app 2 (for example, the app ID of the app 2) is associated with information indicative of the second display area DA2 (disassociation), and newly generates and stores, in the RAM 12, first association information in which the app information of the app 2 is associated with information indicative of the first display area DA1. Then, the control unit 18 returns to the processing in step S101 (see FIG. 9).

As described above, when the window being displayed in the first display area DA1 is moved to the second display area DA2, or when the window being displayed in the second display area DA2 is moved to the first display area DA1, the information processing device 10 according to the present embodiment updates the first association information and the second association information according to the display state after the movement.

Thus, in the information processing device 10, when the window of an app once launched is then moved from the first display area DA1 to the second display area DA2 or from the second display area DA2 to the first display area DA1, since a new sub-window to be opened is displayed in the display area after the movement, the new sub-window does not interfere with the visibility of the window of any other app being displayed in the other display area.

### Third Embodiment

Next, a third embodiment of the present invention will be described.

In the first and second embodiments, the display area DA of one display unit 150 included in the information processing device 10 is split into two display areas of the first display area DA1 and the second display area DA2 to configure the two-screen mode, but the present invention is not limited thereto. For example, the information processing device 10 may also have such a structure as to include two display units.

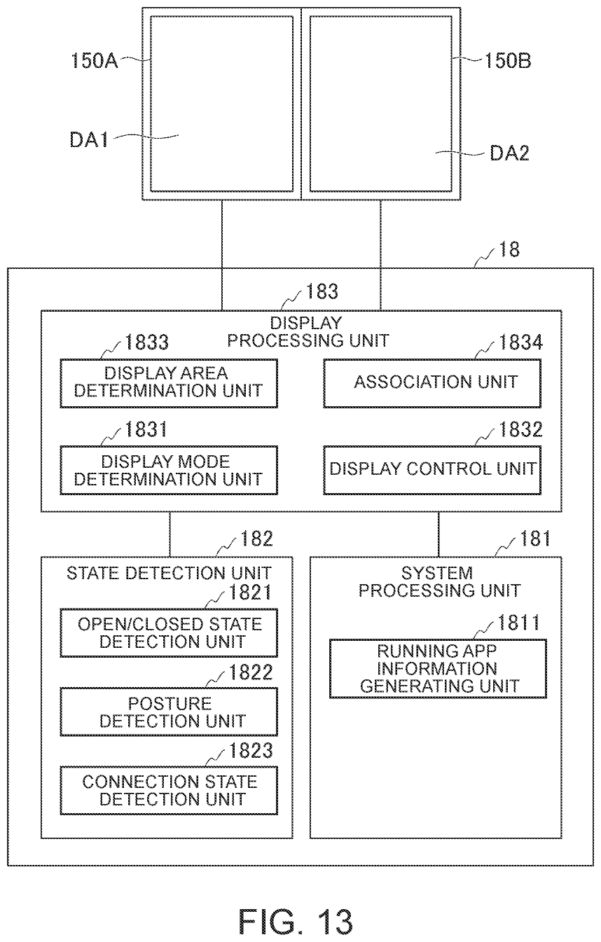

FIG. 12 is a block diagram illustrating an example of the hardware configuration of an information processing device 10A according to this embodiment. The illustrated information processing device 10A includes the communication unit 11, the RAM (Random Access Memory) 12, the storage unit 13, the speaker 14, a first touch screen 15A, a second touch screen 15B, the first acceleration sensor 161, the second acceleration sensor 162, the Hall sensor 17, and the control unit 18. These units are connected communicably to one another through a bus or the like. The first touch screen 15A includes a first display unit 150A and a first touch sensor 155A. The second touch screen 15B includes a second display unit 150B and a second touch sensor 155B. In other words, the hardware configuration of the information processing device 10A is different from the hardware configuration of the information processing device 10 illustrated in FIG. 6 in that two display units of the first display unit 150A and the second display unit 150B are included.

FIG. 13 is a block diagram illustrating an example of the functional configuration related to display control processing according to the present embodiment. Like in the configuration illustrated in FIG. 7, the illustrated control unit 18 includes the system processing unit 181, the state detection unit 182, and the display processing unit 183. In the present embodiment, a display area of the first display unit 150A corresponds to the first display area DA1, and a display area of the second display unit 150B corresponds to the second display area DA2, where the display areas become two display areas in the two-screen mode. Further, in the one-screen mode, the display area of the first display unit 150A and the display area of the second display unit 150B are combined as one display area DA. The display processing unit 183 controls the display of the first display unit 150A and the second display unit 150B to execute the window display control processing as described in the first and second embodiments.

Note that the configuration example illustrated in FIG. 12 and FIG. 13 is so described that the information processing device 10A includes the two display units, but one or both of the two display units may also be external display devices (external monitors).

While the embodiments of this invention have been described in detail with reference to the accompanying drawings, the specific configurations are not limited to those described above, and various design changes and the like can be made without departing from the scope of this invention. For example, the configurations described in the above respective embodiments may be combined arbitrarily with each other.

Further, in the above-described embodiments, the examples of the display mode (b) in which the first display area DA1 and the second display area DA2 are lined up side by side are illustrated and mainly described. However, as described above, even in the case of the display mode (c-1) in which the first display area DA1 and the second display area DA2 are lined in the up and down direction, the above-described window display control processing can be applied in the same manner. In other words, the alignment and orientation of the first display area DA1 and the second display area DA2 are not limited at all.

Further, in the specific examples of the various display modes of the information processing device 10 illustrated in FIG. 5, only the example of the one-screen mode is described in the flat state (Flat form) in which the first chassis 101 and the second chassis 102 are not bent (i.e., in the case of the so-called tablet mode). However, the present invention is not limited thereto, and the information processing device 10 may also be able to switch between the one-screen mode and the two-screen mode even in the flat state (Flat form). For example, when detecting an operation on the screen mode switching icon in the state of the display mode (d′) or the display mode (e′), the information processing device 10 may switch from the one-screen mode to the two-screen mode. Specifically, when switching from the display mode (d′) to the two-screen mode, the information processing device 10 may control the first display area DA1 and the second display area DA2 to be lined up side by side in portrait orientation like in the display mode (b) to execute the window display control processing. Further, when switching from the display mode (e′) to the two-screen mode, the information processing device 10 may control the first display area DA1 and the second display area DA2 to be lined up and down in landscape orientation like in the display mode (c-1) to execute the window display control processing.

Further, in the above-described embodiments, the examples of the window display control processing for two display areas of the first display area DA1 and the second display area DA2 are described, but the window display control processing may also be applied to three or more display areas. For example, as for each of the three or more display areas, a new sub-window of an app may be displayed in a display area in which the main window of the app is being displayed. Further, the three or more display areas may be one flexible display unit (display) capable of being folded in three or more, or three or more separated display units (displays), or a combination thereof. Further, some or all of the three or more display areas may be external display devices (external monitors).

Further, in the above-described embodiments, the examples of touch operations on one or two touch panel displays, each of which is composed integrally of an input unit (touch sensor) and a display unit, are described, but the operations are not limited to the touch operations, and the operations may also be click operations using a mouse, operations by gesture, and the like.

Note that the above-described control unit 18 has a computer system therein. Then, a program for implementing the function of each component included in the control unit described above may be recorded on a computer-readable recording medium in such a manner that the program recorded on this recording medium is read into the computer system and executed to perform processing in each component included in the control unit 18 described above. Here, the fact that “the program recorded on the recording medium is read into the computer system and executed” includes installing the program on the computer system. It is assumed that the “computer system” here includes the OS and hardware such as a peripheral device and the like. Further, the “computer system” may also include two or more computers connected through any of networks including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. The recording medium with the program stored thereon may be a non-transitory recording medium such as the CD-ROM.

A recording medium internally or externally provided to be accessible from a delivery server for delivering the program is included as the recording medium. Note that the program may be divided into plural pieces, downloaded at different timings, respectively, and then united in each component included in the control unit 18, or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the functions of the control unit 18 in the above-described embodiments may be realized as an integrated circuit such as LSI (Large Scale Integration). Each function may be a processor implemented individually, or part or whole thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, in the above-described embodiments, the example in which the information processing device 10 (10A) is a clamshell PC is described, but the information processing device 10 (10A) may also be a tablet PC or a desktop PC. Further, the information processing device 10 (10A) is not limited to the PC, and it may also be a smartphone, a game console, or the like.

### DESCRIPTION OF SYMBOLS

10, 10A: information processing device, 101: first chassis, 102: second chassis, 103: hinge mechanism, 11: communication unit, 12: RAM, 13: storage unit, 14: speaker, 15: touch screen, 15A: first touch screen, 15B: second touch screen, 150: display unit, 150A: first display unit, 150B: second display unit, 155: touch sensor, 155A: first touch sensor, 155B: second touch sensor, 161: first acceleration sensor, 162: second acceleration sensor, 17: Hall sensor, 18: control unit, 181: system processing unit, 1811: running app information generating unit, 182: state detection unit, 1821: open/closed state detection unit, 1822: posture detection unit, 1823: connection state detection unit, 183: display processing unit, 1831: display mode determination unit, 1832: display control unit, 1833: display area determination unit, 1834: association unit.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An information processing device capable of controlling a display in each of a plurality of display areas that do not overlap one another, the information processing device comprising:
a display control unit that:
when a window corresponding to a running application is displayed in a first display area among the plurality of display areas, displays, in the first display area, a new sub-window corresponding to the running application, regardless of whether any of the plurality of display areas other than the first display area are in use, and
when the window corresponding to the running application is displayed in a second display area among the plurality of display areas, displays, in the second display area, the new sub-window corresponding to the running application, regardless of whether any of the plurality of display areas other than the second display area are in use.

2. The information processing device according to claim 1, further comprising:
a first association unit that stores first association information in which information indicative of a first application corresponding to a window displayed in the first display area among the plurality of display areas is associated with information indicative of the first display area; and
a second association unit that stores second association information in which information indicative of a second application corresponding to a window displayed in the second display area among the plurality of display areas is associated with information indicative of the second display area,
wherein when a new sub-window corresponding to the first application is displayed, the display control unit refers to the first association information to display the new sub-window corresponding to the first application in the first display area, while when a new sub-window corresponding to the second application is displayed, the display control unit refers to the second association information to display the new sub-window associated with the second application in the second display area.

3. The information processing device according to claim 2, wherein even when the window displayed in the first display area is moved to the second display area or when the window displayed in the second display area is moved to the first display area, the display control unit refers to the first association information and the second association information before a movement of the window displayed in the first area or of the window displayed in the second area to display the new sub-window corresponding to the first application in the first display area or to display the new sub-window corresponding to the second application in the second display area.

4. The information processing device according to claim 2, wherein when the window displayed in the first display area is moved to the second display area or when the window displayed in the second display area is moved to the first display area, the first association unit and the second association unit update the first association information and the second association information according to a display state after a movement of the window displayed in the first area or of the window displayed in the second area.

5. The information processing device according to claim 1, further comprising:
a determination unit that determines which display area among the plurality of display areas the window corresponding to the running application is being displayed in, wherein
when the window corresponding to the running application is displayed across the first display area and the second display area, the determination unit determines that a higher percentage of the window corresponding to the running application is being displayed in either the first display area or the second display area, and
when the new sub-window corresponding to the running application is displayed, the display control unit displays the new sub-window in the display area determined by the determination unit, to have the higher percentage.

6. The information processing device according to claim 5, wherein when the new sub-window corresponding to the running application is displayed, the display control unit displays the new sub-window corresponding to the running application in an entirety of the display area determined by the determination unit, to have the higher percentage.

7. A control method for an information processing device capable of controlling a display in each of a plurality of display areas that do not overlap one another, the control method comprising:
when a window corresponding to a running application is displayed in a first display area among the plurality of display areas, displaying, in the first display area, a new sub-window corresponding to the running application in the first display area regardless of whether any of the plurality of display areas other than the first display area are in use; and
when the window corresponding to the running application is displayed in a second display area among the plurality of display areas, displaying, in the second display area, the new sub-window corresponding to the running application in the second display area, regardless of whether any of the plurality of display areas other than the second display area are in use.
